(19) United States
(12) Patent Application Publication
(10) Pub. No.: US 2025/0025889 A1
(43) Pub. Date: Jan. 23, 2025

(54) AIR FILTERING PROCESS AND HEATING, VENTILATION, AND AIR CONDITIONING SYSTEM

(71) Applicants: MAHLE INTERNATIONAL GMBH, Stuttgart (DE); KARLSRUHER INSTITUT FÜR TECHNOLOGIE, Eggenstein-Leopoldschafen (DE)

(72) Inventors: Daniel EBERLE, Ludwigsburg (DE); Sven PETZNER, Welzheim (DE); Andrei BOLOGA, Stutensee (DE); Hans-Joachim GEHRMANN, Weingarten (DE)

(21) Appl. No.: 18/772,504

(22) Filed: Jul. 15, 2024

(30) Foreign Application Priority Data
Jul. 18, 2023 (DE) 102023206819.2

(51) Int. Cl. B03C 3/12; B01D 46/00; B03C 3/08; B03C 3/41; F24F 8/30

(52) U.S. Cl. CPC B03C 3/12; B01D 46/0032; B01D 46/0036; B03C 3/08; B03C 3/41; F24F 8/30; B03C 2201/06; B03C 2201/30

(57) ABSTRACT

A heating, ventilation, and air conditioning system (HVAC system) for a motor vehicle is provided, which has an ionizer for generating a corona discharge field, which contains at least one polarized discharge electrode and at least one counter electrode with the opposite polarity of the discharge electrode, a particle filter for removing particles from an air flow, and a flow path that defines a flow direction for air leading to a vehicle interior and conducts the air through the ionizer and the particle filter, wherein the ionizer is upstream of the particle filter in the flow path.

The ionization effect can be improved when the discharge electrodes have numerous needles that point in the flow direction for the air, or counter to the flow direction for the air, and when the discharge electrodes and dedicated counter electrodes are spaced apart in a direction transverse to the flow direction for the air.

### CROSS-REFERENCE TO RELATED APPLICATIONS

This application claims priority from German Patent Application No. DE 102023206819.2, filed on Jul. 18, 2023, the entirety of which is hereby fully incorporated by reference herein.

The present invention relates to an air filtering process for a heating, ventilation, and air conditioning system in a motor vehicle. The invention also relates to a heating, ventilation, and air conditioning system for a motor vehicle according to the preamble of claim 6.

A heating, ventilation, and air conditioning system is frequently referred to as an HVAC system.

An HVAC system of this type is disclosed in EP 3 056 364 B1, and contains an ionizer for generating a corona discharge, which has at least one electrically polarized discharge electrode and at least one oppositely polarized counter electrode. The HVAC system also contains a particle filter for removing particles from an air flow. Lastly, the HVAC system contains an flow path for the air that leads to a vehicle interior and passes through the ionizer and the particle filter. The ionizer is upstream of the particle filter in the flow path. In existing HVAC systems, the counter electrode is cylindrical, and the discharge electrode is concentric to the counter electrode, and parallel to the longitudinal central axis thereof.

Other HVAC systems using ionization are disclosed in EP 3 488 933 A1, KR 10-2205159 B1, US 2021/0 021 107 A1, WO 2020/263171 A1, and WO 2021/226639 A2.

These HVAC systems are used in particular when there is comparatively little installation space for the particle filter, while at the same time, a high level of filtration for larger quantities of air is desired over a longer time period. A high filtration level can be obtained with smaller pores in the particle filter. Smaller pores result in higher flow resistance, however. To compensate for this, the surface area through which air can flow can be increased. The increase in surface area is limited by the available installation space. In particular where there are high levels of particulate matter, a particle filter with sufficiently small pores can only achieve the desired level of filtration for the amount of air that is required for a short time, because it quickly becomes clogged, and the flow resistance increases to unacceptable levels. By using particle filters that have been electrostatically charged in the production process, fine particles can be filtered out of the air, even with larger pores, if these particles have been ionized. The particles bond through electrostatic attraction to the charged filter material. The particles are ionized by an ionizer. An electrostatic field, referred to as a corona discharge field, is generated for this between a discharge electrode and a counter electrode. The discharge electrode preferably has a negative polarity, while the counter electrode then has a positive polarity, or is grounded. The corona discharge is generated at the sharp tips of the negative discharge electrode, consequently generating a large number of electrons moving at high speed toward the opposing electrodes. When these electrons collide with gas molecules in the air flow, either more electrons are released, or the electrons bond with the gas molecules. In the first case, new electrons are released, and positive gas ions are formed, and in the second case, negative gas ions are formed. This gas ionization can also be obtained with reversed polarity, i.e. a positive discharge electrode and negative counter electrode.

The particles are charged by the gas ions, starting when the particles enter the corona discharge space in the discharge flow. The particles are charged when gas ions bond with the particles by colliding therewith. The charging process is obtained with field and diffusion charging.

In practice, the original electrostatic charge of the particle filter obtained in the production process diminishes over time, such that the filtration effect of the particle filter diminishes significantly after a short time. To compensate for this, the replacement intervals for the particle filter can be significantly shortened, but this increases costs substantially.

The problem addressed by the present invention is to create an improved or at least different embodiment for an HVAC system of the above type for an air filtering process, which is distinguished in particular by a high level of filtration of large air quantities over a long service life.

This problem is solved according to the invention by the subject matter of the independent claims. Advantageous embodiments are the subject matter of the dependent claims.

The air filtering process according to the invention for an HVAC system in a motor vehicle is based on the general concept of polarizing the particle filter with an electric field in order to electrostatically charge it. The electric field needed for this according the invention is generated with an ionizer. The already existing ionizer can therefore be used for an additional function. The polarization of the particle filter results in an electrostatic charging of the particle filter, thus improving the filtration effect on particles. In particular, the electrostatic charging can restore the electrostatic charge obtained in the production process. In other words, the polarization of the particle filter results in a restoration thereof.

In an advantageous embodiment, the particle filter can have at least one electrically conductive layer to which on an electric potential opposite that of the discharge electrode is applied, such that an electric field is generated between the ionizer and the particle filter when the ionizer is in operation. The particle filter can be ionized by the electric field between the ionizer and the particle filter. This electric field can therefore also be referred to as a polarization field. The electrostatic charge of the particle filter is basically restored by the polarization thereof. Consequently, a basically constant filtration level can be obtained over the intended service life of the particle filter, even when dealing with large air quantities. The respective potential can be provided at the electrically conductive layer of the particle filter by connecting this layer with a counter-potential that is opposite that of the discharge electrode.

In one advantageous embodiment, the conductive layer is only connected to the counter-potential until the polarization of the particle filter reaches a predefined threshold. Once this polarization threshold has been reached, the conductive layer in the particle filter is disconnected from the counter-potential. The conductive layer could also only be connected to the counter-potential for a predetermined polarization time. Once this time has elapsed, the conductive layer in the particle filter is disconnected from the counter-potential. In this case, the time is monitored. There is therefore no need to monitor the polarization level. These measures are based on the fact that after the particle filter has been polarized, the electrostatic charge obtained therewith diminishes slowly when the HVAC system is in use, specifically due to the particles filtered out of the air flow. The disconnection of the counter-potential removes the electric field between the ionizer and the particle filter, such that the ionizer consumes less electricity. This results in an energy-efficient operation of the HVAC system.

While generating the electric field for polarizing the particle filter, the ionizer consumes more electricity. This generates ozone in the air flow. When the conductive layer is disconnected from the counter-potential, less electricity is used by the ionizer, resulting in less ozone being generated, thus reducing the ozone levels in the vehicle interior.

In an advantageous version of the air filtering process, the conductive layer can be disconnected from the counter-potential only until the polarization of the particle filter falls below a predefined depolarization threshold. In other words, the electrostatic charge of the particle filter is monitored. Once this falls below the depolarization threshold, the polarization is resumed to restore the electrostatic charge. This restoration, or polarization, can basically be repeated as often as needed. Once the depolarization threshold has been reached, the conductive layer is reconnected to the counter-potential. The particle filter is then repolarized. Alternatively, the conductive layer can only be disconnected from the counter-potential until a predefined depolarization time has elapsed. After this depolarization time has elapsed, the conductive layer is reconnected to the counter-potential. In this case, time is monitored. There is no need to monitor the polarization.

The polarization time and/or depolarization time are dependent on the application for which the particle filter is intended, in which certain conditions must be take into account, e.g. the size of the particle filter, the intended filtration effect, and/or the amount of air and particulate matter where the particle filter is to be used.

An embodiment in which the discharge electrode is positive and the counter electrode is negative is fundamentally advantageous. An embodiment in which the discharge electrode is negative and the counter electrode is positive is preferred, however. This results in a particularly efficient ionization.

In one advantageous embodiment, the counter electrode can be permanently connected to the counter-potential, and the conductive layer in the particle filter is connected to the counter electrode to connect it to the counter-potential. This is a particularly simple design.

The HVAC system according to the invention is based on the general concept of equipping the discharge electrodes with numerous needles that point in or against the direction in which the air flows. These needles protrude from a needle substrate toward or against the flow direction. The discharge electrodes and their dedicated counter electrodes are spaced apart across the flow path.

In an advantageous embodiment, the discharge electrodes can have numerous needles on the upstream side, extending in the flow direction and away from the particle filter.

The tips thereof are thus facing away from the particle filter.

In one advantageous embodiment, the discharge electrodes can have numerous needles on the downstream side, extending in the flow direction and toward the particle filter. With downstream needles pointing toward the particle filter, the tips thereof face the particle filter. Although an embodiment in which the discharge electrodes have upstream and downstream needles is preferred, embodiments lacking either the downstream or upstream needles are also possible.

If there are numerous upstream and downstream needles, a configuration in which the upstream needles on an upstream side of the needle substrate are spaced apart evenly is preferred. The downstream needles on the downstream side of the needle substrate can also be spaced apart evenly, at the same spacing as the upstream needles. It may also be advantageous if the upstream needles are offset to the downstream needles, such that they are each located in the middle, between two downstream needles.

In an advantageous embodiment, the counter electrode can form a plate, preferably a flat plate. The plate-shaped counter electrode can be parallel to the discharge electrode. The plate is flat, and the thickness thereof is less than the length and width. The plate can be placed in the air flow such that the width thereof is parallel to the flow direction of the air, and the length and thickness are transverse thereto. Consequently, the air only flows against a narrow edge of the counter electrode. The discharge electrodes and dedicated counter electrodes can also extend in straight lines, preferably transverse to the flow direction of the air. This structure results in an efficient generation of the corona discharge in order to effectively ionize the particles in the air flow. Furthermore, this configuration is relatively small in relation to the flow direction.

In an advantageous embodiment, there can be at least one conductive layer in the particle filter, which can be connected to a counter-potential that is opposite the potential of the discharge electrode. This provides an electrical connection for the HVAC system with which the conductive layer is connected to the counter-potential. In the simplest case, this can be obtained with the ground wire connected to the ground for the ionizer.

In the present context, a “configuration” means the same as a “design” and/or “programing,” such that the formulation “configured such that” has the same meaning as “designed and/or programmed such that.”

An embodiment in which the electrical connection can be switched on and off is advantageous. This allows for the conductive layer to be connected and disconnected from the counter-potential as needed. The conductive layer of the particle filter connected to the counter-potential can thus be polarized when the ionizer is in use in order to restore its electrostatic charge. When it has been sufficiently charged, further polarization can be stopped by disconnecting it from the counter-potential, in order to conserve electricity. The switching capability of the connection can be obtained with an electromechanical or electronic switch, for example.

An embodiment in which the HVAC system contains a control unit that is configured to execute the above air filtering process when the HVAC system is in use is particularly advantageous. In other words, the control unit controls the components of the HVAC system that can be controlled, specifically the ionizer and the switchable connection, to execute the above air filtering process.

The dielectric layer of the particle filter can contain or be made of a nonwoven sheet. These are normally made of a synthetic and are therefore dielectric. Nonwoven sheets can be produced with a melt blowing process. The particle filtering layer determines the pore size of the particle filter, and is impermeable to particles that are larger than the pore size.

In another embodiment, the conductive layer of the particle filter can form an adsorption filtering layer, containing or made of activated carbon. Because of the abutting activated carbon particles, which are conductive, the adsorption filtering layer as a whole is also conductive, and can be used to form the polarizing electric field, because it is grounded. The adsorption filtering layer filters through adsorption, which functions in particular for gas molecules. The activated carbon particles can bond to a nonwoven layer, or be contained between two nonwoven layers.

Instead of, or in addition to the adsorption filtering layer, the conductive layer in the particle filter can also form a grid structure, containing or made of conductive wires, fibers, or filaments. Unlike a particle filter layer, or an adsorption filtering layer, the grid structure has no significant filtration effect.

It is advantageous when the dielectric layer lies on the conductive layer and is therefore in contact therewith. In particular, the conductive layer extends over the entire dielectric layer. This results in the electric field generated by the grounding of the conductive layer also acting on the dielectric layer, such that the dielectric layer can also be polarized, or electrostatically charged.

A particularly advantageous configuration has proven to be one in which the dielectric layer in the particle filter is upstream of the conductive layer. This results in the electrons and/or ions in the electric field with which the charging and polarization of the particle filter is obtained colliding with the dielectric layer on the way to the conductive layer, and remaining there to obtain the desired polarization.

Other important features and advantages of the invention can be derived from the dependent claims, the drawings, and the descriptions of the drawings.

It is understood that the features specified above and explained below can be used not only in the given combinations, but also in other combinations or in and of themselves, without abandoning the scope of the invention. The components of a higher order unit, e.g. a device, apparatus, or assembly, that are indicated individually, can form separate components of this unit, or integral parts thereof, even if otherwise indicated in the drawings.

Preferred exemplary embodiments of the invention are shown in the drawings, and shall be explained in greater detail below, in which the same reference symbols are used for the same, similar, or functionally identical components.

Therein, schematically:

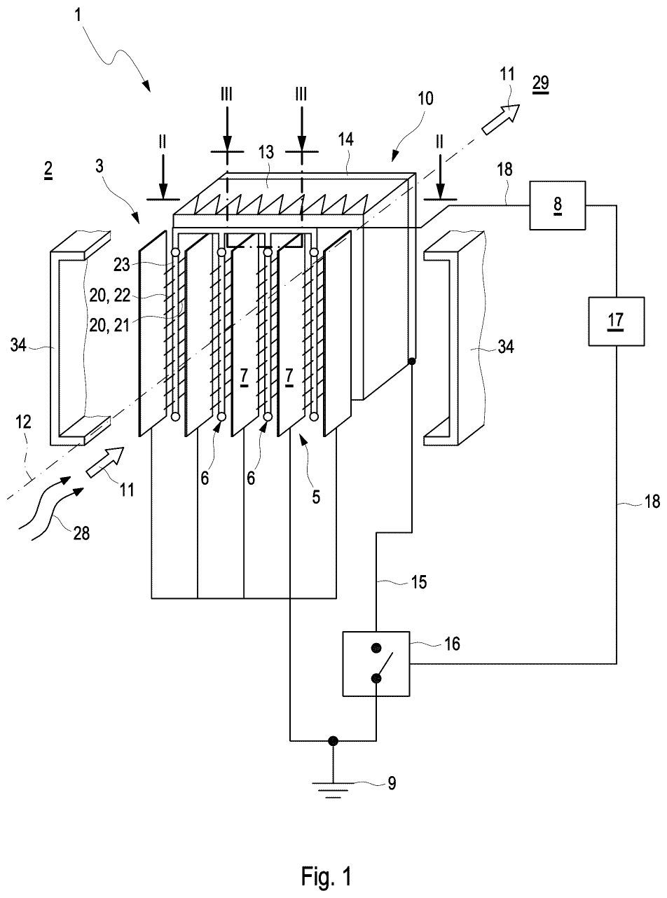

FIG. 1 shows a simplified circuit diagram illustration of an HVAC system that has a particle filter and an ionizer;

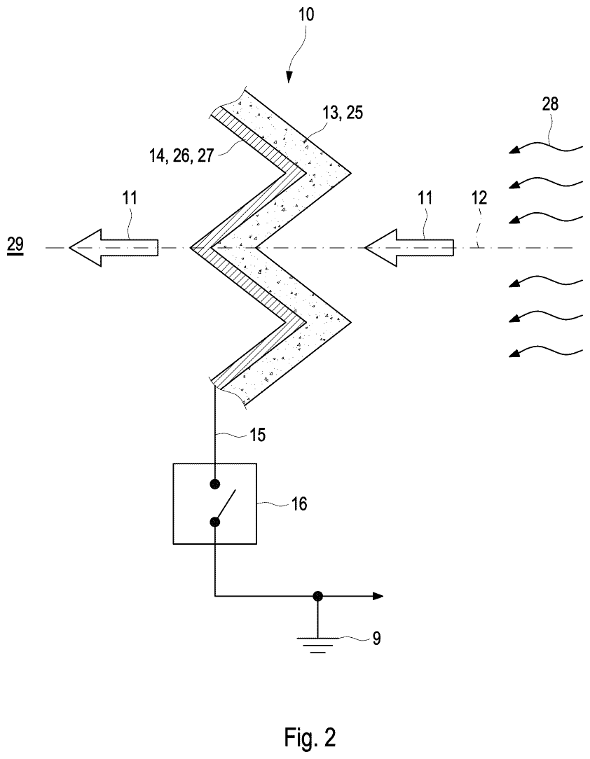

FIG. 2 shows a simplified cross section of the particle filter corresponding to the line II in FIG. 1;

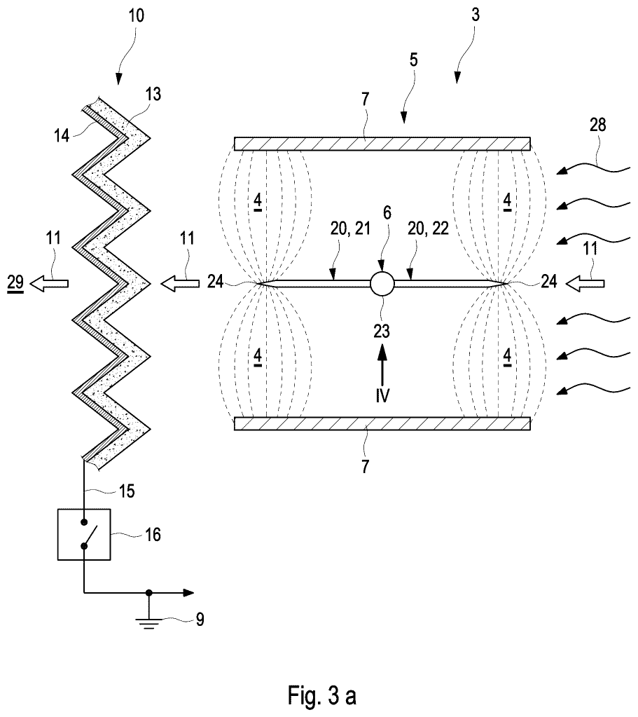

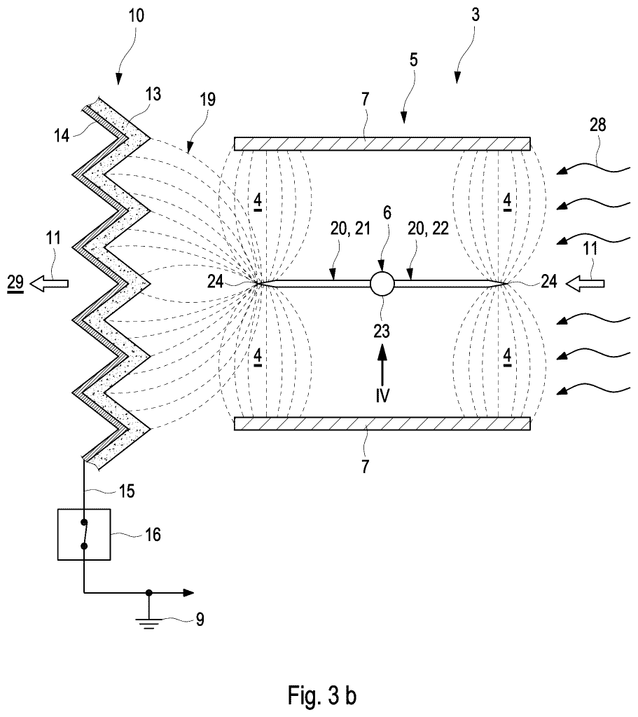

FIG. 3 shows a simplified cross section of the ionizer corresponding to the line III in FIG. 1 where there is a pair of electrodes in different states a and b; and

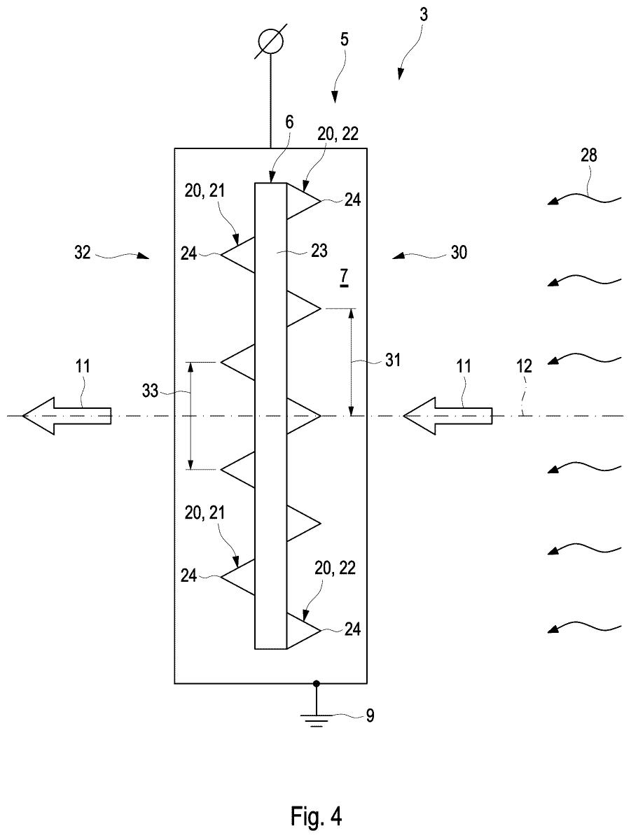

FIG. 4 shows a simplified side view of the electrode pair from FIG. 3, from the perspective IV in FIG. 3.

The HVAC system 1 for a motor vehicle (not shown) in FIG. 1 contains an ionizer 3 with which a corona discharge field 4, indicated a broken line in FIG. 3, can be generated. The ionizer 3 has at least one pair of electrodes 5 for this, one of which is a negative or positive discharge electrode 6, and the other is a counter electrode 7 with the opposite polarity. Four such electrode pairs 7 are shown in FIG. 1. In other embodiments, more than two, in particular three or more, such electrode pairs 5 can be used. In particular, there can be n discharge electrodes 6 and n+1 counter electrodes 7 in the ionizer 3, such that each discharge electrode 6 is between two counter electrodes 7 in a direction transverse to the flow direction 11. Only one counter electrode 7 is shown in FIG. 3, for purposes of simplicity.

The discharge electrode 6, which can also be referred to as an emitter electrode, is connected to a high voltage source 8, which provides a DC current of 5 kV to 10 KV, preferably approx. 7 kV. The counter electrodes 7 are connected to a counter-potential 9 with the opposite polarity of the discharge electrode. In this case, the discharge electrodes 6 have a negative polarity, and the dedicated counter electrodes 7 have a positive polarity. The counter-potential 9 is therefore also positive, as indicated in FIGS. 1 and 2 by the ground symbol.

The HVAC system 1 also has a particle filter 10 with which particles are removed from an air flow 28, indicated by the wave-shaped arrows in the drawings. The air flow 28 flows in a flow direction 11 when the HVAC system 1 is in use, indicated by line composed of dashes and dots in the drawings. The flow path 12 defines the flow direction 11 for the air. The flow path 12 passes through the ionizer 3 and the particle filter 10. It should be noted that the ionizer 3 is upstream of the particle filter 10 in the flow path 12. The air in the flow path 12 flows into the interior 29 of the vehicle 2, not shown in detail. The air can be fresh air surrounding the vehicle 2 or recirculating air from the vehicle interior 29, or a mixture thereof.

The particle filter 10 in FIGS. 1 and 2 has multiple layers, comprising at least one dielectric layer 13 and at least one electrically conductive layer 14. The HVAC system 1 also has an electrical connection, with which the conductive layer 14 is connected to the counter-potential 9. The electrical connection 15 can have a switch, as shown in FIG. 1. By way of example, the connection 15 can contain a switch 16 with which the electrical connection between the conductive layer 14 and the counter-potential 9 can be switched on and off. In FIG. 1, the conductive layer 14 can be connected to the counter electrode 7 by the connection 15. When this connection 15 is switched on, the conductive layer 14 is connected to the counter-potential 9 by the counter electrode 7.

The HVAC system 1 in FIG. 1 can also have a control unit 17, which is connected to the high voltage source 8 and the switch 16, e.g. by control lines 18. The control unit 17 can be configured to execute the air filtering process described in greater detail below.

In the air filtering process, an air flow 28 polluted with particles first flows through the ionizer 3 and then the multi-layered particle filter 10 along the flow path 12. The ionizer generates the corona discharge field 4 with the discharge electrodes and dedicated counter electrodes 7 at this point. The air flow 28 that is to be filtered passes through the corona discharge field 4. The particles in the air flow 28 are ionized in the corona discharge field 4. The conductive layer 14 is also connected to the counter-potential 9 by the connection 15 during the air filtering process, such that an electric field 19 is generated between the ionizer 3 and the particle filter 10, which is indicated in FIGS. 3 and 4 by broken lines, and referred to below as the polarization field 19. The polarization field 19 polarizes the particle filter 10, such that it becomes electrostatically charged.

The conductive layer 14 only has to be connected to the counter-potential 9 in the air filtering process until the particle filter reaches a predetermined polarization threshold, and/or until a predetermined polarization time has elapsed. Once the predetermined polarization threshold has been reached, or the predetermined polarization time has elapsed, the conductive layer 14 in the particle filter 10 is disconnected from the counter-potential 9. This can take place by switching off the switch 16. The electrostatic charge of the particle filter 10 then diminishes during the filtration process, due to the particles accumulating thereon. Furthermore, the conductive layer 14 only has to be disconnected from the counter potential 9 in the air filtering process until the polarization of the particle filter 10, i.e. the electrostatic charge, reaches a predetermined depolarization threshold, and/or a predetermined depolarization time has elapsed. Once the predetermined depolarization threshold has been reached, or the depolarization time has elapsed, the conductive layer 14 in the particle filter 10 is reconnected to the counter-potential 9. This can be obtained by switching the switch 16 on. In particular, the conductive layer 14 can first be connected to the counter-potential 9 when the electrostatic charge in the particle filter 10 reaches the predetermined depolarization threshold, and/or when the predetermined depolarization time has elapsed.

As shown in FIGS. 1, 3 and 4, the discharge electrodes 6 can have numerous needles 20 protruding from a needle substrate 23, which have tips 24 at the ends pointing away from the substrate 23, which is only shown in detail in FIGS. 3 and 4. The discharge electrodes 6 and counter electrodes 7 in the pairs of electrodes 5 are spaced apart in a direction transverse to the flow direction 11, such that the flow path 12 for the air flow 28 can pass between the discharge electrodes 6 and the counter electrodes 7. When there are numerous adjacent pairs 5 transverse to the flow direction 11, each discharge electrode 6 can be between two counter electrodes 7 and interact with the two counter electrodes 7 to generate the corona discharge field 4.

The needles 20 on the discharge electrodes 6 can be parallel to the flow direction 11. They therefore protrude from the substrate 23 in or against the flow direction. The needles 20 form pins in FIGS. 1 and 3. They are conical or shaped like pyramids in FIG. 4. Plate-shaped needles 20 can also be used, which are pointed at one end, to form the tips 24 of the needles.

The discharge electrodes 6 can have numerous needles 21 on the downstream side, pointing toward the particle filter, as shown in FIGS. 1, 3 and 4. In other words, the needles 21 on the downstream side protrude from the substrate 23 toward the particle filter 10. Consequently, the tips 24 of the downstream needles 21 face toward the particle filter 10. These downstream needles 21 are preferably parallel to the flow direction 11 for the air.

The discharge electrodes 6 can also have numerous upstream needles 22, which face away from the particle filter 10. In other words, the upstream needles 22 protrude from the substrate 23 away from the particle filter 10. The tips 24 of these upstream needles 22 then also point away from the particle filter 10. The upstream needles 22 are ideally parallel to the flow direction 11 for the air. The upstream needles 22 are mainly used for generating the corona discharge field 4.

When the high voltage potential is applied to the discharge electrodes 6, and the switch 16 is switched off, as shown in FIG. 3a, the electric corona discharge field 4 is formed between the discharge electrodes 6 and the counter electrodes 7, specifically between the tips 24 of the needles 21 and 22, and the counter electrodes 7. This electric field, i.e. the corona discharge field 4 is primarily responsible for electrostatically charging the particles in the air flow 28. When the high voltage potential is applied to the discharge electrodes 6 and the switch 16 is switched on, as shown in FIG. 3b, and connected to the counter electrode 9, the electric corona discharge field 4 is primarily formed between the discharge electrodes 6 and the counter electrodes 7, specifically between the tips 24 of the needles 21 and 22, and the counter electrodes 7, such that an additional electric field 19 is formed between the tips 24 of the downstream needles 21 and the filter element 10, primarily the filter element layer 14. In this case, the electric field 19 is primarily used for the polarization or restoring of the layer 13 in the filter 10. The intensity of the electric field 19 is strong when the switch 16 is on, and weak when the switch 16 is off.

The discharge electrodes 6 can be mounted on the dielectric high voltage insulators, which are part of a housing 34 for the HVAC system 1 shown in FIG. 1, or they can be separate units in the housing 34 for the HVAC system 1. These insulators are not shown in the drawings. The high voltage insulators can have a variety of shapes and be made of a variety of dielectric materials. These insulators insulate the discharge electrodes 6 from the counter electrodes 7, which have an opposite polarity, or are grounded, or from a grounded housing 34 for the HVAC system 1, or from grounded parts of the vehicle, or from the grounded vehicle 2.

The upstream needles 22 in FIG. 4, which are on the upstream side 30 of the needle substrate 23, are at a predefined spacing 31 to one another. The downstream needles 21 on the downstream side 32 of the substrate 23 are also at a predefined spacing 33 to one another. The spacing 31 between the upstream needles 22 is ideally the same as the spacing 33 between the downstream needles 21. Furthermore, it is preferable that the upstream needles 22 are placed in the middle between two downstream needles 21 on the substrate 23, such that each upstream needle 22 is spaced apart from the adjacent downstream needle 21 on the substrate by one half the spacing 31 or 33.

The counter electrodes 7 can form plates, which are parallel to the discharge electrodes 6. These counter electrodes 7 can therefore form flat plates. The discharge electrodes 6 and counter electrodes 7 can be straight and parallel to one another, and perpendicular to the flow direction 11 for the air. By way of example, the needle substrates 23 form straight rods. The plate-shaped counter electrodes 7 in FIG. 1 are parallel to one another, and in planes that are parallel to the flow direction 11 of the air flow 28. The counter electrodes 7 are therefore spaced apart in a direction transverse to the flow direction 11.

The dielectric layer 13 of the particle filter 10 in FIG. 2 can be a particle filtering layer 25 formed by at least one nonwoven sheet. The conductive layer 14 in the particle filter 10 can form an adsorption filtering layer 26 containing activated carbon. In addition to, or instead of the adsorption filtering layer 26, the conductive layer 14 of the particle filter 10 can also form a grid structure 27, formed by conductive wires, fibers, or filaments.

The conductive layer 14 is on the dielectric layer 13 in the particle filter 10, and is therefore in contact therewith. This contact is preferably over the entire surface. In particular, the conductive layer 14 can extend over the entire downstream or upstream surface of the dielectric layer 13. The particle filter 10 in FIG. 2 is pleated, such that the conductive layer 14 follows the folds of the dielectric layer 13 and is also pleated. This configuration, in which the dielectric layer 13 in the particle filter 10 is upstream of the conductive layer 14, is preferred. Fundamentally, the dielectric layer 13 can also be downstream of the conductive layer 14 in the particle filter 10.

The HVAC system 1 can also contain a heater for heating the air flow 28, and a cooler for cooling and dehumidifying the air flow 28.

The specification can be readily understood with reference to the following Representative Paragraphs:

Representative Paragraph 1. An air filtering process for a heating, ventilation, and air conditioning system (HVAC system) (1), in a motor vehicle (2), in which
an air flow (28) polluted with particles first flows through an ionizer (3) and then through a particle filter (10),
the ionizer (3) generates a corona discharge field (4) with at least one polarized discharge electrode (6) and at least one counter electrode (7) that has the opposite polarization of the discharge electrode,
the air flow (28) to be filtered passes through the corona discharge field (4), such that the particles therein are ionized, and
the particle filter (10) is polarized by the ionizer (3) when an electric field (19) is generated by the ionizer (3) for polarizing the particle filter (10).

Representative Paragraph 2. The air filtering process according to Representative Paragraph 1, characterized in that
the particle filter (10) has multiple layers, and contains at least one dielectric layer (13) and at least one electrically conductive layer (14),
the conductive layer (14) in the particle filter (10) is connected to a counter-potential (9) that has the opposite polarity of the discharge electrode (6), in order to generate the electric field (19) for polarizing the particle filter (10) between the ionizer (3) and the particle filter (10).

Representative Paragraph 3. The air filtering process according to Representative Paragraph 2, characterized in that
the conductive layer (14) is only connected to the counter-potential until the polarization of the particle filter (10) reaches a predetermined polarization threshold, or a predetermined polarization time has elapsed,
when the predetermined polarization threshold has been reached, or the polarization time has elapsed, the conductive layer (14) of the particle filter (10) is disconnected from the counter-potential (9).

Representative Paragraph 4. The air filtering process according to Representative Paragraph 3, characterized in that
the conductive layer (14) is only disconnected from the counter-potential (9) until the polarization of the particle filter (10) reaches a predetermined depolarization threshold, or a predetermined depolarization time has elapsed,
the conductive layer (14) in the particle filter (10) is reconnected to the counter-potential (9) when the predetermined depolarization threshold has been reached, or the depolarization time has elapsed.

Representative Paragraph 5. The air filtering process according to any of the Representative Paragraphs 1 to 4, characterized in that
the discharge electrode (6) has a negative polarity, while the counter electrode (7) and the counter-potential (9) have a positive polarity, or
the discharge electrode (6) has a positive polarity, while the counter electrode (7) and counter-potential (9) have a negative polarity, and/or
the counter electrode (7) is electrically connected to the counter-potential (9), and the conductive layer (14) in the particle filter (10) is connected to the counter electrode (7), in order to connect the conductive layer (14) to the counter-potential (9).

Representative Paragraph 6. A heating, ventilation, and air conditioning system (HVAC system) (1) for a motor vehicle (2), which has
an ionizer (3) for generating a corona discharge field (4), which contains at least one polarized discharge electrode (6) and at least one counter electrode (7) with the opposite polarity of the discharge electrode (6),
a particle filter (10) for removing particles from an air flow (28), and
a flow path (12) that defines a flow direction (11) for air leading to a vehicle interior (29) and conducts the air through the ionizer (3) and the particle filter (10),
wherein the ionizer (3) is upstream of the particle filter (10) in the flow path (12), characterized in that
the discharge electrodes (6) have numerous needles (20), which point in the flow direction (11) of the air, or against the flow direction (11) of the air, and
the discharge electrodes (6) and dedicated counter electrodes (7) are spaced apart from one another in a direction transverse to the flow direction (11).

Representative Paragraph 7. The HVAC system (1) according to Representative Paragraph 6, characterized in that
the discharge electrodes (6) have numerous upstream needles (22), which point away from the particle filter (10), such that the tips (24) of these upstream needles (22) face away from the particle filter (10).

Representative Paragraph 8. The HVAC system (1) according to Representative Paragraph 6 or 7, characterized in that
the discharge electrodes (6) have numerous downstream needles (21) that point toward the particle filter (10), such that the tips (24) of the downstream needles (21) face toward the particle filter (10).

Representative Paragraph 9. The HVAC system (1) according to any of the Representative Paragraphs 6 to 8, characterized in that
the counter electrodes (7) form plates, in particular flat plates, which are parallel to the discharge electrodes (6) and/or
the discharge electrode (6) and the dedicated counter electrodes (7) extend in a straight line, preferably transverse to the flow direction (11) for the air.

Representative Paragraph 10. The HVAC system (1) according to any of the Representative Paragraphs 6 to 9, characterized in that
the electrical connection (15) can be switched on and off, such that the conductive layer (14) can be connected to and disconnected from the counter-potential (9).

Representative Paragraph 11. The HVAC system (1) according to any of the Representative Paragraphs 6 to 10, characterized in that
the HVAC system (1) has a control unit (17) with which the air filtering process according to any of the Representative Paragraphs 1 to 5 can be executed.

Representative Paragraph 12. The HVAC system (1) according to any of the Representative Paragraphs 6 to 11, characterized in that
the particle filter (10) has numerous layers and contains at least one dielectric layer (13) and at least one conductive layer (14),
the HVAC system (1) has an electrical connection (15) for connecting a counter-potential (9) to the conductive layer (14), which has the opposite polarity of the discharge electrode (7).

Representative Paragraph 13. The HVAC system (1) according to any of the Representative Paragraphs 6 to 12, characterized in that
the dielectric layer (13) in the particle filter (10) is a particle filtering layer (25), which contains or is made of a nonwoven sheet.

Representative Paragraph 14. The HVAC system (1) according to any of the Representative Paragraphs 6 to 13, characterized in that
the conductive layer (14) in the particle filter (10) forms an adsorption filtering layer (26), which contains or is composed of activated carbon particles, or
the conductive layer (14) in the particle filter (10) is a grid structure (27), which contains or is composed of conductive wires, fibers, or filaments.

Representative Paragraph 15. The HVAC system (1) according to any of the Representative Paragraphs 6 to 14, characterized in that
the dielectric layer (13) is placed on the conductive layer (14), and is therefore in contact therewith.

Representative Paragraph 16. The HVAC system (1) according to any of the Representative Paragraphs 6 to 15, characterized in that
the dielectric layer (13) is upstream of the conductive layer (14) in the particle filter (10).

Representative Paragraph 17. The HVAC system (1) according to any of the Representative Paragraphs 6 to 16, characterized in that
the upstream needles (22) on the upstream side (30) of the needle substrate (23) are at a predefined spacing (31) to one another, and/or
the downstream needles (21) on the downstream side (32) of the needle substrate (23) are at a predefined spacing (33) to one another, and/or
the spacing (31) between the upstream needles (22) is the same as the spacing (33) between the downstream needles (21), and/or
the at least one downstream needle (21) is substantially in the middle, between two adjacent upstream needles (22).

1. An air filtering process for a heating, ventilation, and air conditioning system (HVAC system), in a motor vehicle, comprising
an air flow polluted with particles first flows through an ionizer and then through a particle filter,
the ionizer generates a corona discharge field with at least one polarized discharge electrode and at least one counter electrode that has the opposite polarization of the discharge electrode,
the air flow to be filtered passes through the corona discharge field, such that the particles therein are ionized, and
the particle filter is polarized by the ionizer when an electric field is generated by the ionizer for polarizing the particle filter.

2. The air filtering process according to claim 1, wherein
the particle filter comprises multiple layers, and contains at least one dielectric layer and at least one electrically conductive layer,
the conductive layer in the particle filter is connected to a counter-potential that has the opposite polarity of the discharge electrode, in order to generate the electric field for polarizing the particle filter between the ionizer and the particle filter.

3. The air filtering process according to claim 2, wherein
the conductive layer is connected to the counter-potential until the polarization of the particle filter reaches a predetermined polarization threshold, or a predetermined polarization time has elapsed,
when the predetermined polarization threshold has been reached, or the polarization time has elapsed, the conductive layer of the particle filter is disconnected from the counter-potential.

4. The air filtering process according to claim 3, wherein
the conductive layer is disconnected from the counter-potential until the polarization of the particle filter reaches a predetermined depolarization threshold, or a predetermined depolarization time has elapsed,
the conductive layer in the particle filter is reconnected to the counter-potential when the predetermined depolarization threshold has been reached, or the depolarization time has elapsed.

5. The air filtering process according to claim 1, wherein
the discharge electrode has a negative polarity, while the counter electrode and the counter-potential have a positive polarity, or
the discharge electrode has a positive polarity, while the counter electrode and counter-potential have a negative polarity, and/or
the counter electrode is electrically connected to the counter-potential, and the conductive layer in the particle filter is connected to the counter electrode, in order to connect the conductive layer to the counter-potential.

6. A heating, ventilation, and air conditioning system (HVAC system) for a motor vehicle, comprising
an ionizer configured to generate a corona discharge field, which contains at least one polarized discharge electrode and at least one counter electrode with the opposite polarity of the discharge electrode,
a particle filter configured to remove for removing particles from an air flow, and
a flow path that defines a flow direction for air leading to a vehicle interior, the flow path is configured to conduct the air through the ionizer and the particle filter,
wherein the ionizer is upstream of the particle filter in the flow path,
wherein the discharge electrodes have numerous needles, which point in the flow direction of the air, or against the flow direction of the air, and
the discharge electrodes and dedicated counter electrodes are spaced apart from one another in a direction transverse to the flow direction.

7. The HVAC system according to claim 6, wherein
the discharge electrodes have numerous upstream needles, which point away from the particle filter, such that the tips of these upstream needles face away from the particle filter.

8. The HVAC system according to claim 6, wherein
the discharge electrodes have numerous downstream needles that point toward the particle filter, such that the tips of the downstream needles face toward the particle filter.

9. The HVAC system according to claim 6, wherein
the counter electrodes form flat plates which are parallel to the discharge electrodes and/or
the discharge electrode and the dedicated counter electrodes extend in a straight line.

10. The HVAC system according to claim 6, wherein
the electrical connection can be switched on and off, such that the conductive layer can be connected to and disconnected from the counter-potential.

11. The HVAC system according to claim 6, wherein
the HVAC system has a control unit with which the air filtering process is configured to be executed.

12. The HVAC system according to claim 6, wherein
the particle filter has numerous layers and contains at least one dielectric layer and at least one conductive layer,
the HVAC system has an electrical connection for connecting a counter-potential to the conductive layer, which has the opposite polarity of the discharge electrode.

13. The HVAC system according to claim 6, wherein
the dielectric layer in the particle filter is a particle filtering layer, which comprises or contains a nonwoven sheet.

14. The HVAC system according to claim 6, wherein
the conductive layer in the particle filter forms an adsorption filtering layer, which comprises or contains activated carbon particles, or
the conductive layer in the particle filter is a grid structure, which comprises or contains conductive wires, fibers, or filaments.

15. The HVAC system according to claim 6, wherein characterized in that
the dielectric layer is placed on the conductive layer, and is therefore in contact therewith.

16. The HVAC system according to claim 6, wherein
the dielectric layer is upstream of the conductive layer in the particle filter.

17. The HVAC system according to claim 6, wherein
the upstream needles on the upstream side of the needle substrate are at a predefined spacing to one another, and/or
the downstream needles on the downstream side of the needle substrate are at a predefined spacing to one another, and/or
the spacing between the upstream needles is the same as the spacing between the downstream needles, and/or
the at least one downstream needle is substantially in the middle, between two adjacent upstream needles.

18. The HVAC system of claim 9, wherein the discharge electrode and the dedicated counter elect extend transverse to the flow direction for the air.

19. The HVAC system of claim 11, wherein the air filtering process comprises:
air flow polluted with particles first flows through the ionizer and then through the particle filter with multiple layers
the ionizer generating a corona discharge field with at least one polarized discharge electrode and at least one counter electrode that has the opposite polarization of the discharge electrode,
the air flow to be filtered passing through the corona discharge field, such that the particles therein are ionized, and
the particle filter is polarized by the ionizer when an electric field is generated by the ionizer for polarizing the particle filter.
